(19) United States
(12) Patent Application Publication
(10) Pub. No.: US 2020/0385590 A1
(43) Pub. Date: Dec. 10, 2020

(54) DEVICE FOR A LIGHT SOURCE OF A PRINTING MACHINE WITH A PLURALITY OF LIGHT-EMITTING SEMICONDUCTOR COMPONENTS OF A FIRST TYPE AND AT LEAST ONE LIGHT-EMITTING SEMICONDUCTOR COMPONENT OF A FURTHER TYPE ON A SUBSTRATE

(71) Applicant: Heraeus Noblelight GmbH, Hanau (DE)

(72) Inventor: Andreas STAHL, Hanau (DE)

(21) Appl. No.: 16/893,809

(22) Filed: Jun. 5, 2020

(30) Foreign Application Priority Data
Jun. 6, 2019 (DE) 102019208308.0

(51) Int. Cl. C09D 11/101; B41J 11/00; C09D 11/30

(52) U.S. Cl. CPC C09D 11/101; C09D 11/30; B41J 11/002

(57) ABSTRACT

A device comprising an electrical circuit on a substrate. The circuit includes light-emitting semiconductor components having a plurality of a first type and at least one of a further type, and a first plurality of parallel circuit paths. Each first type component emits light with a spectrum comprising a local intensity maximum in a first wavelength range; each further type component, in a further wavelength range different from the first wavelength range. At least one of the parallel circuit paths comprises a further type component. No operating voltage sum of the parallel circuit paths differs by more than 0.6 V from an operating voltage sum of the parallel circuit paths. Also disclosed are a light source; a printing machine; methods, in particular for producing a printed product and for irradiating an irradiation material; a printed product; an arrangement; and uses of the light source.

### RELATED APPLICATION

This application claims the benefit of priority to German Patent Application Number DE 10 2019 208 308.0, filed on Jun. 6, 2019, the contents of which are incorporated in this application by reference.

### TECHNICAL FIELD

The present disclosure pertains generally to the printing industry and, more specifically, to a light source; a printing machine; methods, in particular for producing a printed product and for irradiating an irradiation material; a printed product; an arrangement of the light source; and uses of the light source.

### BACKGROUND OF THE DISCLOSURE

In the technical field of the invention—the printing industry—the use of light sources for curing printing inks and lacquers has been known for a long time. Furthermore, the use of UV-curable inks and lacquers—i.e., inks and lacquers that can be cured by irradiation with suitable ultraviolet radiation—is also known. Conventionally, mercury vapor lamps are used for curing such inks and lacquers. However, these light sources have considerable disadvantages, for example with regard to their service life, maintenance intensity and heat generation. This has already been recognized in the prior art. As a result, light-emitting semiconductor components, especially light-emitting diode (LED) modules, are increasingly being used instead of mercury vapor lamps for irradiating UV-curable inks and lacquers. Although the use of light-emitting diodes already opens up many advantages over the well-known mercury vapor lamps, there is room for improvement in the design of light sources with LEDs, especially, but not exclusively, with UV LEDs.

Due to their function, light-emitting semiconductor components such as LEDs have a narrower emission spectrum than conventional light sources such as mercury vapor lamps. To cure inks and lacquers, these often have to be irradiated with light, especially UV light, of a certain spectrum. Since this spectrum depends on the respective ink or lacquer, luminaires with LEDs of the same spectrum are not very flexible in their application. Furthermore, inks and lacquers may require a spectrum that contains a combination of certain wavelengths, or a spectrum that is as uniform as possible over a predetermined range. In order to accommodate the above-mentioned cases in the most flexible way possible, an LED luminaire must contain a large number of LED types with different emission spectra. For this purpose, the prior art uses a combination of several LED modules, with each module contributing LEDs of one type. This solution has considerable disadvantages. If the LED luminaire is to be as flexible as possible, or provide the widest possible spectrum, it must contain many different LED modules. This results in a duality between the requirements for the emission spectrum of the luminaire and a design that is as compact as possible. The latter is particularly desirable for use in printing machines. Furthermore, an intensity distribution of a luminaire with several LED modules often shows stripes or steps, which makes a homogeneous illumination of larger areas more difficult. When curing large-area ink and lacquer applications, inhomogeneities, and thus quality losses, can occur as a result. A particular argument against combining several LEDs of different types in one LED module is that LEDs of different types often have different operating voltages. However, an LED module is often designed for a specific operating voltage, so that it is fixed to one LED type. Even if the voltage supply and circuitry of an LED module were configured in such a way that a predetermined operating voltage drops at each LED of the module, such an LED module would still be very prone to error. In the worst case, the failure of a single LED can lead to the failure of the entire module. Therefore, this solution has not been accepted thus far.

In general, it is an object of the present invention to at least partially overcome the disadvantages inherent in the prior art.

A further object of the invention is to provide a light source for a printing machine which is suitable for curing as many different printing inks and lacquers, in particular UV-curable printing inks and lacquers, as spatially homogeneously as possible, by irradiation with light from light-emitting semiconductor components, in particular light-emitting diodes. For this purpose, the light source can have an emission spectrum with intensity maxima at different wavelengths, or an emission spectrum that is as broad as possible. Furthermore, the spatially most-homogeneous curing is made possible in particular by reducing or avoiding stripes and/or steps in an intensity distribution of an irradiation with the light source on a target surface which contains the printing ink or the lacquer. A further object of the invention is to provide the aforementioned light source, the aforementioned emission spectrum being at least predominantly in the UV range. A further object of the invention is to provide a semiconductor light source whose emission spectrum combines UV-A components with UV-B and/or UV-C components. Furthermore, it is an object of the invention to provide a semiconductor light source whose emission spectrum possibly covers the entire UV-A range.

Furthermore, it is an object of the invention to provide a light source for a printing machine which is suitable for curing as many different printing inks and lacquers, in particular UV-curable printing inks and lacquers, as possible by irradiation with light from light-emitting semiconductor components, in particular light-emitting diodes, and which is as least susceptible to malfunction, in particular to failure, as possible. In this context, defects in individual semiconductor components of the light source affect the total emission as little as possible. A further object of the invention is to provide a light source for a printing machine which is characterized by the longest possible service life.

A further object of the invention is to provide a light source with the most compact design possible for a printing press. Furthermore, it is an object of the invention to provide a light source for a printing machine which can be produced by a method which is as simple as possible and/or by a method which takes as little production time as possible. Furthermore, it is an object of the invention to provide a light source for a printing machine, wherein the light source is characterized by an advantageous balance of compact design on the one hand and manufacturability by a simple method and/or a method of short production time on the other hand. The above compact design is preferably achieved by the smallest possible ratio of an area of a substrate to an emission area of the light source.

Furthermore, one of the objects of the invention is to provide an LED module in a light source which contributes to the solution of one of the above-mentioned objects.

A further object of the invention is to provide a light source for a printing machine, whereby the light source can be adapted as flexibly as possible, and with as little effort as possible, to a printing ink or lacquer to be cured, in particular a UV-curable printing ink or lacquer. Furthermore, an object of the invention is to provide LED modules for the aforementioned adaptation of the light source. A further object of the invention is to provide an LED module for the least costly retrofitting of an existing light source for a printing machine. With the aforementioned retrofitting, the existing light source can be improved, preferably for solving one of the objects described above.

A further object of the invention is to provide a light source, preferably a UV light source, for a printing machine, whereby the light source is characterized by an increased service life. This object is preferably solved by the light source on a substrate having as few components as possible which can degrade during operation of the light source by electromagnetic radiation, such as active or passive electrical elements (e.g., ohmic resistors, integrated circuits, etc.) under irradiation of UV light.

Furthermore, it is an object of the invention to provide a printing machine containing one of the advantageous light sources described above. Accordingly, this printing machine preferably exhibits one or more of the advantages described above for the light source.

### SUMMARY OF THE INVENTION

A contribution to the at least partial fulfilment of at least one, preferably several, of the above objects is provided by the disclosed embodiments. The present invention pertains to a device comprising:
a) a substrate, and
b) an electrical circuit arranged on the substrate, comprising a first section, including:
   i) a first plurality of light-emitting semiconductor components, having:
      A) a plurality of light-emitting semiconductor components of a first type, and
      B) at least one light-emitting semiconductor component of a further type, and
   ii) a first plurality of parallel circuit paths connected in parallel;
      wherein each of the parallel circuit paths of the first plurality of parallel circuit paths includes
a. a first end, and
b. an oppositely-positioned further end;
   wherein the first ends of the parallel circuit paths of the first plurality of parallel circuit paths are electro-conductively connected to each other; wherein the further ends of the parallel circuit paths of the first plurality of parallel circuit paths are electro-conductively connected to each other; wherein each light-emitting semiconductor component of the first type is arranged and adapted to emit light with a spectrum comprising a local intensity maximum in a first wavelength range upon application of an operating voltage of the light-emitting semiconductor component of the first type; wherein each light-emitting semiconductor component of the further type is arranged and adapted to emit light with a spectrum comprising a local intensity maximum in a further wavelength range, different from the first wavelength range, upon application of an operating voltage of the light-emitting semiconductor component of the further type; wherein at least one of the parallel circuit paths of the first plurality of parallel circuit paths comprises a light-emitting semiconductor component of the further type; wherein each parallel circuit path of the first plurality of parallel circuit paths is characterized by an operating voltage sum, which is a sum of the operating voltages of the light-emitting semiconductor components in the respective parallel circuit path; characterized in that no operating voltage sum of the parallel circuit paths of the first plurality of parallel circuit paths differs by more than 0.6 V from an operating voltage sum of the parallel circuit paths of the first plurality of parallel circuit paths. Furthermore, the invention pertains to a light source; a printing machine; methods, in particular for producing a printed product and for irradiating an irradiation material; a printed product; an arrangement of the light source according to the invention; and uses of the light source according to the invention.

A contribution to the fulfilment of at least one of the objects according to the invention is made by an embodiment 1 of a device, comprising:
a) a substrate, and
b) an electrical circuit arranged on the substrate, including a first section, having:
   i) a first plurality of light-emitting semiconductor components, comprising
      A) a plurality of light-emitting semiconductor components of a first type, and
      B) at least one light-emitting semiconductor component of a further type, and
   ii) a first plurality of parallel circuit paths connected in parallel;
wherein each of the parallel circuit paths of the first plurality of parallel circuit paths comprises:
   a. a first end, and
   b. preferably in a forward direction of the light-emitting semiconductor components of the first plurality of light-emitting semiconductor components or against this forward direction, an oppositely-positioned further end;
wherein the first ends of the parallel circuit paths of the first plurality of parallel circuit paths are electro-conductively connected to each other; wherein the further ends of the parallel circuit paths of the first plurality of parallel circuit paths are electro-conductively connected to each other; wherein each light-emitting semiconductor component of the first type is arranged and adapted to emit light with a spectrum comprising a local intensity maximum in a first wavelength range upon application of an operating voltage of the light-emitting semiconductor component of the first type; wherein each light-emitting semiconductor component of the further type is arranged and adapted to emit light with a spectrum comprising a local intensity maximum in a further wavelength range, different from the first wavelength range, upon application of an operating voltage of the light-emitting semiconductor component of the further type; wherein at least one of the parallel circuit paths of the first plurality of parallel circuit paths comprises a light-emitting semiconductor component of the further type; wherein each parallel circuit path of the first plurality of parallel circuit paths is characterized by an operating voltage sum, which is a sum of the operating voltages of the light-emitting semiconductor components in the respective parallel circuit path; characterized in that no operating voltage sum of the parallel circuit paths of the first plurality of parallel circuit paths differs by more than 0.6 V, preferably by more than 0.5 V, more preferably by more than 0.4 V, still more preferably by more than 0.3 V, even more preferably by more than 0.2 V, most preferably by more than 0.1 V from an operating voltage sum of the parallel circuit paths of the first plurality of parallel circuit paths. The first plurality of parallel circuit paths comprises at least two, preferably at least three, more preferably at least four, parallel circuit paths. The first plurality of light-emitting semiconductor components of the first type comprises at least two, preferably at least four, more preferably at least five, even more preferably at least eight light-emitting semiconductor components of the first type. It is alternatively or additionally preferred that the plurality of light-emitting semiconductor components of the first type comprises at least twice as many light-emitting semiconductor components of the first type as the first plurality of light-emitting semiconductor components comprises those of the further type.

In an embodiment 2 according to the invention, the device is designed according to its embodiment 1, wherein the first wavelength range extends over a range from 315 to 450 nm, preferably from 350 to 420 nm, more preferably from 360 to 410 nm.

In an embodiment 3 according to the invention, the device is designed according to its embodiment 1 or 2, wherein the further wavelength range extends over a range from 280 to less than 315 nm; or over a range from 10 to less than 280 nm, preferably from 100 to less than 280 nm, more preferably from 200 to less than 280 nm; or over both ranges. Preferably, the further wavelength range comprises a wavelength range of UV-B radiation, or of UV-C radiation, or of both. Particularly preferred, the further wavelength range comprises a wavelength range of UV-C radiation, or of UV-C radiation and UV-B radiation. More preferably, the further wavelength range consists of a wavelength range of UV-B radiation, or of UV-C radiation, or of both wavelength ranges, whereby the wavelength range of UV-C radiation or of UV-C radiation and UV-B radiation is particularly preferred.

In an embodiment 4 according to the invention, the device is designed according to one of its previous embodiments, wherein each light-emitting semiconductor component of the first type is arranged and adapted to emit light with a spectrum comprising a local intensity maximum in the first wavelength range with a full-width-at-half-maximum in a range from 3 to 50 nm, preferably from 5 to 40 nm, more preferably from 10 to 30 nm, most preferably from 15 to 25 nm.

In an embodiment 5 according to the invention, the device is designed according to one of its previous embodiments, wherein each light-emitting semiconductor component of the further type is arranged and adapted to emit light with a spectrum comprising a local intensity maximum in the further wavelength range with a full-width-at-half-maximum in a range of 3 to 50 nm, preferably 5 to 40 nm, more preferably 10 to 30 nm, most preferably 15 to 25 nm.

In an embodiment 6 according to the invention, the device is designed according to one of its previous embodiments, wherein the first plurality of light-emitting semiconductor components comprises at least one first light-emitting semiconductor component of the further type and at least one further light-emitting semiconductor component of the further type, wherein the at least one first light-emitting semiconductor component of the further type is arranged and adapted to emit light with a spectrum comprising a local intensity maximum in a wavelength range from 280 to less than 315 nm, wherein the at least one further light-emitting semiconductor component of the further type is arranged and adapted to emit light with a spectrum comprising a local intensity maximum in a wavelength range from 10 to less than 280 nm, preferably from 100 to less than 280 nm, more preferably from 200 to less than 280 nm.

In an embodiment 7 according to the invention, the device is designed according to one of its previous embodiments, wherein the first plurality of light-emitting semiconductor components comprises at least one selected from the group consisting of a light-emitting semiconductor component of the first type arranged and adapted to emit light with a spectrum comprising a local intensity maximum at a wavelength in a range from 360 to 370 nm, preferably from 363 to 367 nm; a light-emitting semiconductor component of the first type arranged and adapted to emit light with a spectrum comprising a local intensity maximum at a wavelength in a range from 380 to 390 nm, preferably from 383 to 387 nm; a light-emitting semiconductor component of the first type arranged and adapted to emit light with a spectrum comprising a local intensity maximum at a wavelength in a range from 390 to 400 nm, preferably from 393 to 397 nm; and a light-emitting semiconductor component of the first type arranged and adapted to emit light with a spectrum comprising a local intensity maximum at a wavelength in a range from 400 to 410 nm, preferably from 403 to 407 nm; or a combination of at least two of these.

In an embodiment 8 according to the invention, the device is designed according to one of its previous embodiments, the light-emitting semiconductor components of the first type being characterized by first operating voltages, the light-emitting semiconductor components of the further type being characterized by further operating voltages different from the first operating voltages. The first operating voltages can be the same or different from one another. Furthermore, the further operating voltages can be the same or different from one another. Each of the further operating voltages differs from each of the first operating voltages preferably by at least 1 V, more preferably by at least 2 V, even more preferably by at least 3 V, most preferably by at least 3.5 V.

In an embodiment 9 according to the invention, the device is designed according to its embodiment 8, wherein the first operating voltages lie in a range from 3 to 4.5 V.

In an embodiment 10 according to the invention, the device is designed according to its embodiment 8 or 9, wherein the further operating voltages lie in a range from 6.5 to 9 V.

In an embodiment 11 according to the invention, the device is designed according to one of its previous embodiments, wherein no light-emitting semiconductor component of a parallel circuit path of the first plurality of parallel circuit paths is connected in series with a light-emitting semiconductor component of a different parallel circuit path of the first plurality of parallel circuit paths. The two light-emitting semiconductor components are connected in series when they are connected in an electro-conductive manner, and one after the other in a direction of current flow, in the electrical circuit. Short-circuited circuit paths are not regarded as a series connection. The above configuration allows, in particular, a low susceptibility to failure of the device and of a light source comprising the device.

In an embodiment 12 according to the invention, the device is designed according to one of its previous embodiments, wherein the parallel circuit paths of the first plurality of parallel circuit paths together comprise the first plurality of light-emitting semiconductor components.

In an embodiment 13 according to the invention, the device is designed according to one of its previous embodiments, wherein each light-emitting semiconductor component of the first type is characterized by an operating current in a range of 0.3 to 3 A, preferably 0.4 to 2 A, more preferably 0.5 to 1.5 A.

In an embodiment 14 according to the invention, the device is designed according to one of its previous embodiments, wherein each light-emitting semiconductor component of the further type is characterized by an operating current in a range from 100 mA to 1 A, preferably from 200 to 800 mA, more preferably from 250 to 600 mA.

In an embodiment 15 according to the invention, the device is designed according to one of its previous embodiments, wherein the plurality of light-emitting semiconductor components of the first type comprises at least two, preferably at least three, more preferably at least four light-emitting semiconductor components arranged and adapted to emit light with spectra comprising local intensity maxima at different respective wavelengths. The aforementioned local intensity maxima are preferably at wavelengths which differ from one another by at least 3 nm, more preferably at least 5 nm, even more preferably at least 8 nm, most preferably at least 9 nm, for example by about 10 nm.

In an embodiment 16 according to the invention, the device is designed according to its embodiment 15, wherein the at least two light-emitting semiconductor components of the plurality of light-emitting semiconductor components of the first type are arranged in different parallel circuit paths of the first plurality of parallel circuit paths.

In an embodiment 17 according to the invention, the device is designed according to one of its previous embodiments, wherein the substrate is formed as one piece. An article is formed as one piece if it is manufactured in one piece, preferably from a formless material, without subsequent joining of different parts. Accordingly, the substrate preferably does not comprise a joint, such as a seam, weld, solder or adhesive joint.

In an embodiment 18 according to the invention, the device is designed according to one of its previous embodiments, wherein the substrate comprises a ceramic, preferably consisting thereof.

In an embodiment 19 according to the invention, the device is designed according to one of its previous embodiments, wherein the substrate comprises one selected from the group consisting of aluminum nitride, aluminum oxide, preferably AlO, and a metal, or a combination of at least two thereof, preferably consisting thereof. A preferred metal is aluminium or copper or both.

In an embodiment 20 according to the invention, the device is designed according to one of its previous embodiments, wherein the substrate comprises, as superimposed layers of a layer sequence, in a direction from one side of the substrate facing the electrical circuit to an opposite side of the substrate (a) a coating, and (b) a carrier layer.

A preferred carrier layer comprises one selected from the group consisting of aluminum nitride, aluminum oxide, preferably AlO, and a metal, or a combination of at least two thereof. More preferably, the substrate consists of the above. A preferred metal is aluminium or copper or both. A preferred coating comprises a glass. A preferred coating is electrically insulating. A preferred coating is obtained from a paste, more preferably a thick film paste, such as Heraeus Celsion® which is available from Heraeus Deutschland GmbH & Co. KG.

In an embodiment 21 according to the invention, the device is designed according to one of its previous embodiments, wherein the electrical circuit comprises a first double-T-shaped conductive track, wherein the first double-T-shaped conductive track comprises a first transverse bar, a further transverse bar and a longitudinal bar electrically connecting the first transverse bar to the further transverse bar. A preferred first double-T-shaped conductive track is a printed conductive track. This configuration allows, in particular, an advantageous balance of a particularly compact design and low manufacturing cost and/or short process duration of a manufacturing process for the device and for a light source comprising the device. Preferably, the first transverse bar, the longitudinal bar and the further transverse bar are arranged, one after the other, in a current flow direction, or in the forward direction of the light-emitting semiconductor components of the first plurality of light-emitting semiconductor components, or opposite this forward direction. It is particularly preferred that the first transverse bar, the longitudinal bar and the further transverse bar are adjacent to one another.

In an embodiment 22 according to the invention, the device is designed according to its embodiment 21, wherein the first transverse bar of the first double-T-shaped conductive track electro-conductively connects the first ends of the parallel circuit paths of the first plurality of parallel circuit paths.

In an embodiment 23 according to the invention, the device is designed according to its embodiment 21 or 22, wherein the first plurality of parallel circuit paths comprises the longitudinal bar or the further transverse bar of the first double-T-shaped conductive track, or both.

In an embodiment 24 according to the invention, the device is designed according to one of its embodiments 21 to 23, wherein the light-emitting semiconductor components of the further type of the first plurality of light-emitting semiconductor components are electro-conductively connected by bonding wires to the longitudinal bar or the further transverse bar of the first double-T-shaped conductive track, or to both.

In an embodiment 25 according to the invention, the device is designed according to one of its embodiments 21 to 24, wherein the electrical circuit additionally comprises a further double-T-shaped conductive track, wherein the further double-T-shaped conductive track comprises a first transverse bar, a further transverse bar, and a longitudinal bar electrically connecting the first transverse bar to the further transverse bar, wherein the first transverse bar of the further double-T-shaped conductive track electro-conductively connects the further ends of the parallel circuit paths of the first plurality of parallel circuit paths. Preferably, the first transverse bar, the longitudinal bar and the further transverse bar of the further double-T-shaped conductive track are arranged, one after the other, in a current flow direction, or in the forward direction of the light-emitting semiconductor components of the first plurality of light-emitting semiconductor components, or opposite this forward direction. Particularly preferred, this first transverse bar, this longitudinal bar and this further transverse bar are adjacent to each other.

In an embodiment 26 according to the invention, the device is designed according to its embodiment 25, wherein the first transverse bar of the first double-T-shaped conductive track along parallel circuit paths of the first plurality of parallel circuit paths, preferably along all parallel circuit paths of the first plurality of parallel circuit paths, is electro-conductively connected by bonding wires to the first transverse bar of the further double-T-shaped conductive track. “By bonding wires” means that the aforementioned parallel circuit paths contain bonding wires. The first two transverse bars can therefore be connected directly by the bonding wires or, which is preferred, indirectly, i.e., with further electrically conductive components between the two first transverse bars.

In an embodiment 27 according to the invention, the device is designed according to its embodiment 25 or 26, wherein the further transverse bar of the first double-T-shaped conductive track is electro-conductively connected to the first transverse bar of the further double-T-shaped conductive track along at least a part of the parallel circuit paths of the first plurality of parallel circuit paths by bonding wires.

In an embodiment 28 according to the invention, the device is designed according to one of its preceding embodiments, wherein the electrical circuit comprises at least one further section, preferably in the forward direction or opposite thereto, arranged after the first section, wherein the further section comprises:
a} a further plurality of light-emitting semiconductor components, including:
   i} a plurality of light-emitting semiconductor components of the first type, and
   ii} at least one light-emitting semiconductor component of the further type; and
b} a further plurality of parallel circuit paths connected in parallel to each other,
   wherein each of the parallel circuit paths of the further plurality of parallel circuit paths includes:
a: a first end, and
b: in a forward direction of the light-emitting semiconductor components of the further plurality of light-emitting semiconductor components or opposite to this forward direction, an oppositely-positioned further end,
   wherein the first ends of the parallel circuit paths of the further plurality of parallel circuit paths are electro-conductively connected to one another, wherein the further ends of the parallel circuit paths of the further plurality of parallel circuit paths are electro-conductively connected to one another, wherein at least one of the parallel circuit paths of the further plurality of parallel circuit paths comprises a light-emitting semiconductor component of the first type, wherein each parallel circuit path of the further plurality of parallel circuit paths is characterized by an operating voltage sum, which is a sum of the operating voltages of the light-emitting semiconductor components in the respective parallel circuit path, wherein no operating voltage sum of the parallel circuit paths of the further plurality of parallel circuit paths differs by more than 0.6 V, preferably by more than 0.5 V, still preferably more than 0.4 V, more preferably by more than 0.3 V, even more preferably by more than 0.2 V, most preferably by more than 0.1 V from an operating voltage sum of the parallel circuit paths of the further plurality of parallel circuit paths. The further plurality of parallel circuit paths comprises at least two, preferably at least three, more preferably at least four parallel circuit paths. The plurality of light-emitting semiconductor components of the first type in the further plurality of light-emitting semiconductor components comprises at least two, preferably at least four, more preferably at least five, even more preferably at least eight light-emitting semiconductor components of the first type. It is alternatively or additionally preferred that the plurality of light-emitting semiconductor components of the first type in the further plurality of light-emitting semiconductor components comprises at least twice as many light-emitting semiconductor components of the first type as the further plurality of light-emitting semiconductor components comprises those of the further type.

In an embodiment 29 according to the invention, the device is designed according to one of its preceding embodiments, wherein the light-emitting semiconductor components of the first type are light-emitting diodes of the first type.

In an embodiment 30 according to the invention, the device is designed according to its embodiment 29, wherein the light-emitting diodes of the first type are UV light-emitting diodes, preferably UV-A light-emitting diodes.

In an embodiment 31 according to the invention, the device is designed according to one of its preceding embodiments, wherein the light-emitting semiconductor components of the further type are light-emitting diodes of the further type.

In an embodiment 32 according to the invention, the device is designed according to its embodiment 31, wherein the light-emitting diodes of the further type are UV light-emitting diodes, preferably UV-B light-emitting diodes or UV-C light-emitting diodes, or a mixture thereof, wherein UV-C light-emitting diodes are particularly preferred.

In an embodiment 33 according to the invention, the device is designed according to one of its preceding embodiments, wherein the light-emitting semiconductor components of the first plurality of light-emitting semiconductor components are light-emitting diodes, preferably UV light-emitting diodes.

In an embodiment 34 according to the invention, the device is designed according to one of its preceding embodiments, wherein the device comprises, preferably is, an LED module.

A contribution to the fulfilment of at least one of the objects according to the invention is made by an embodiment 1 of a light source that comprises the device of the present invention according to one of its embodiments.

In an embodiment 2 according to the invention, the light source is designed according to its embodiment 1, wherein the light source is adapted, preferably additionally arranged, for one selected from the group consisting of use in a printing machine; for a curing of a protective layer; and for a curing of a sheet-like layer of a multilayer composite; or for a combination of at least two thereof. In general, a polymer layer is preferred for the above-mentioned protective layer, as well as for the sheet-like layer. A polymer layer is a layer which, after curing, comprises one or more polymers, in total at least 50 wt-%, preferably at least 60 wt-%, more preferably at least 70 wt-%, still more preferably at least 80 wt %, most preferably at least 90 wt-% based on the total weight of the polymer layer. Preferably the polymer layer consists of one or more polymers. A preferred protective layer is a protective lacquer. A preferred curing of a protective layer is one selected from the group consisting of curing a coating of a component containing wood fibers; curing a coating of a floor covering; and curing a sheath or protective cover, or both, of an optical fiber (also called a fiber optic cable); or a combination of at least two thereof. A preferred multilayer composite is a film. A preferred curing of a sheet-like layer of a multilayer composite is one selected from the group consisting of curing a layer of a display; curing a layer in a film printing process; and curing a layer in a film lamination process; or a combination of at least two thereof. A preferred wood fiber-containing component is a piece of furniture. It is alternatively or additionally preferred that a preferred wood fiber-containing component is at least partly wood. A preferred floor covering is a parquet or laminate floor covering, or both. A preferred display is an electrically controlled display. A preferred electrically controlled display is a screen, preferably a screen of a handheld device (also handheld or hand-device), or a monitor, or both.

In an embodiment 3 according to the invention, the light source is designed according to its embodiment 1 or 2, wherein the light source comprises an electric ballast. A preferred electric ballast is an electronic ballast. A preferred electronic ballast is an LED driver.

A contribution to the fulfilment of at least one of the objects according to the invention is made by an embodiment 1 of a printing machine that comprises the light source of the present invention according to one of its embodiments. Any type of printing machine that is suitable for the use of the light source according to the invention can be considered as a printing machine according to the invention. A preferred printing machine is adapted to carry out method 1 according to one of its embodiments.

In an embodiment 2 according to the invention, the printing machine is designed according to its embodiment 1, wherein the light source is arranged and adapted in the printing machine to irradiate a composition printed on a print carrier.

In an embodiment 3 according to the invention, the printing machine is designed according to its embodiment 2, wherein the composition is a printing ink or a lacquer, or both.

In an embodiment 4 according to the invention, the printing machine is designed according to one of its preceding embodiments, wherein the printing machine comprises a voltage source, wherein the light source is electrically contacted with the voltage source.

In an embodiment 5 according to the invention, the printing machine is designed according to its embodiment 4, wherein the voltage source is characterized by an open-circuit voltage in a range from 10 to 250 V, preferably from 10 to 100 V, more preferably from 30 to 80 V, even more preferably from 40 to 60 V, most preferably of about 48 V.

In an embodiment 6 according to the invention, the printing machine is designed according to its embodiment 4 or 5, wherein the voltage source is characterized by a short-circuit current in a range from 1 to 20 A, preferably from 2 to 10 A, more preferably from 3 to 7 A, even more preferably from 4 to 6 A, most preferably of about 5 A.

In an embodiment 7 according to the invention, the printing machine is designed according to one of its preceding embodiments, wherein the printing machine is a printing machine without a print image-carrying surface. A preferred printing machine without a print image-carrying surface is adapted for Non-Impact Printing (NIP). A preferred printing machine without a print image-carrying surface is an inkjet printer or a laser printer, or both.

In an embodiment 8 according to the invention, the printing machine is designed according to one of its embodiments 1 to 6, wherein the printing machine comprises a print image-carrying surface. A preferred print image-carrying surface is a printing roller or a printing plate. A preferred printing machine which includes a print image-carrying surface is a flexographic printing machine.

In an embodiment 9 according to the invention, the printing machine is designed according to its embodiment 8, wherein the printing machine is arranged and adapted for indirect printing by the print image-carrying surface. A preferred printing machine for indirect printing is an offset printing machine. A preferred offset printing machine is a sheet-fed offset printing machine.

A contribution to the fulfilment of at least one of the objects according to the invention is made by an embodiment 1 of a method 1, comprising as method steps:
A) providing
   I) the light source of the invention according to one of its embodiments, and
   II) an item;
B) superimposing the item with a composition; and
C) irradiating the composition with light emitted from at least a portion of the light-emitting semiconductor components of the first plurality of light-emitting semiconductor components.

In an embodiment 2 according to the invention, method 1 is designed according to its embodiment 1, wherein the composition in method step B), preferably also in method step C), is a liquid.

In an embodiment 3 according to the invention, method 1 is designed according to its embodiment 1 or 2, wherein the composition in method step B) comprises at least one colorant, preferably in a proportion in the range from 0.5 to 20 wt-%, more preferably from 1 to 15 wt-%, even more preferably from 2 to 10 wt-%, most preferably from 3 to 8 wt-%, in each case based on the composition in method step B).

In an embodiment 4 according to the invention, method 1 is designed according to one of its preceding embodiments, wherein the composition in method step B) comprises a vehicle, preferably in a proportion in the range from 10 to 95 wt-%, more preferably from 20 to 95 wt-%, still more preferably from 30 to 95 wt-%, most preferably from 40 to 90 wt %, in each case based on the composition in method step B).

In an embodiment 5 according to the invention, method 1 is designed according to one of its preceding embodiments, wherein the composition in method step B) comprises a photo-initiator, preferably in a proportion in a range from 1 to 30 wt-%, more preferably from 2 to 25 wt-%, still more preferably from 3 to 20 wt-%, most preferably from 5 to 15 wt-%, in each case based on the composition in method step B).

In an embodiment 6 according to the invention, method 1 is designed according to one of its preceding embodiments, wherein the composition in method step B) comprises at least one monomer, preferably in a proportion in the range from 10 to 95 wt-%, more preferably from 20 to 95 wt-%, further preferably from 30 to 90 wt-%, even further preferably from 40 to 85 wt-%, still more preferably from 50 to 85 wt-%, most preferably from 60 to 80 wt-%, in each case based on the composition in method step B).

In an embodiment 7 according to the invention, method 1 is designed according to one of its preceding embodiments, wherein the composition in method step B) comprises at least one oligomer, preferably in a proportion in the range from 1 to 50 wt-%, preferably from 1 to 40 wt-%, more preferably from 2 to 30 wt-%, still more preferably from 3 to 25 wt-%, most preferably from 5 to 20 wt-%, in each case based on the composition in method step B).

In an embodiment 8 according to the invention, method 1 is designed according to one of its preceding embodiments, wherein method step C) comprises a curing of the composition.

In an embodiment 9 according to the invention, method 1 is designed according to its embodiment 8, wherein the curing comprises reducing a proportion of a vehicle in the composition, preferably by at least 50 wt-%, more preferably by at least 60 wt-%, still more preferably by at least 70 wt-%, even more preferably by at least 80 wt-%, most preferably by at least 90 wt-%, in each case based on the proportion of the vehicle in the composition before curing.

In an embodiment 10 according to the invention, method 1 is designed according to its embodiment 8 or 9, wherein the curing comprises polymerizing a monomer or an oligomer, or both, in the composition.

In an embodiment 11 according to the invention, method 1 is designed according to one of its preceding embodiments, wherein the composition is a printing ink or a lacquer, or both.

In an embodiment 12 according to the invention, method 1 is designed according to one of its preceding embodiments, wherein in method step C) the irradiation of the composition with the light emitted by at least a part of the light-emitting semiconductor components of the first plurality of light-emitting semiconductor components comprises an at least partially simultaneous irradiation of the composition with light emitted by at least a part of the light-emitting semiconductor components of the first type and by at least a part of the light-emitting semiconductor components of the further type.

In an embodiment 13 according to the invention, method 1 is designed according to one of its preceding embodiments, wherein the method is a method for producing a printed product.

In an embodiment 14 according to the invention, method 1 is designed according to one of its preceding embodiments, wherein in method step A) the printing machine of the invention is provided according to one of its embodiments.

In an embodiment 15 according to the invention, method 1 is designed according to one of its preceding embodiments, wherein the superimposing in method step B) is a printing of the item with the composition. A preferred item is a print carrier, also called a print substrate. Further preferred items are the items taught in the context of the arrangement in accordance with the invention.

A contribution to the fulfilment of at least one of the objects according to the invention is made by an embodiment 1 of a printed product, obtained by method 1 according to one of its embodiments.

In an embodiment 2 according to the invention, the printed product is designed according to its embodiment 1, wherein the printed product is one selected from the group consisting of a magazine, a book, a poster, an advertising medium, and a label, or a combination of at least two thereof.

A contribution to the fulfilment of at least one of the objects according to the invention is made by an embodiment 1 of an arrangement comprising:
a] the light source of the invention according to one of its embodiments, and
b] an irradiation material,
   wherein the light source and the irradiation material are arranged and adapted for irradiating the irradiation material with light emitted from at least a part of the light-emitting semiconductor components of the first plurality of light-emitting semiconductor components. Preferably, the light source and the irradiation material are arranged and adapted for at least partially simultaneous irradiation of the irradiation material with light emitted by at least a portion of the light-emitting semiconductor components of the first type and by at least a portion of the light-emitting semiconductor components of the further type.

In an embodiment 2 according to the invention, the arrangement is designed according to its embodiment 1, wherein the irradiation material comprises an item and a composition superimposing the item, wherein the light source and the irradiation material are arranged and adapted for irradiating the composition with the light emitted from at least a portion of the light-emitting semiconductor components of the first plurality of light-emitting semiconductor components. A preferred item is one selected from the group consisting of a carrier in the form of a web; a sheet-like multilayer composite; a wood-fiber containing carrier; a floor covering; an optical fiber; a precursor of an optical fiber, including its core; a display; a precursor of a display; or a combination of at least two thereof. A preferred wood-fiber containing carrier comprises, preferably consists of, a wood-based material or paper. A preferred wood-based material is one selected from the group consisting of a solid wood material, a veneer material, a pressed-wood material, a wood fiber material, and a composite material, or a combination of at least two thereof. Another preferred wood fiber-containing carrier is a piece of furniture or a paper web. A preferred floor covering is parquet or laminate flooring, or both. A preferred display is an electrically controlled display. A preferred electrically controlled display is a screen, preferably a screen of a handheld device (also handheld or hand-device), or a monitor, or both. A preferred carrier in the form of a web is a print carrier. Alternatively or additionally, the preferred carrier in the form of a web comprises a paper layer or consists of paper. A preferred carrier in the form of a web that comprises paper is a paper web. A further preferred carrier in the form of a web is a film. Furthermore, a preferred sheet-like multi-layer composite is a film. The composition is preferably designed according to an embodiment of method 1 according to the invention.

A contribution to the fulfilment of at least one of the objects according to the invention is made by an embodiment 1 of a method 2, comprising as method steps:
A] providing the arrangement of the invention according to one of its embodiments; and
B] irradiating the irradiation material with light emitted from at least a portion of the light-emitting semiconductor components of the first plurality of light-emitting semiconductor components.

In an embodiment 2 according to the invention, method 2 is designed according to its embodiment 1, wherein the method is a method for irradiating the irradiation material.

In an embodiment 3 according to the invention, method 2 is designed according to its embodiment 1 or 2, wherein method step B] comprises curing a composition. Method 2 is preferably a method for curing the composition.

In an embodiment 4 according to the invention, method 2 is designed according to its embodiment 3, wherein the curing comprises reducing a proportion of a vehicle in the composition.

In an embodiment 5 according to the invention, method 2 is designed according to its embodiment 3 or 4, wherein the curing comprises polymerizing a monomer or an oligomer, or both, in the composition.

In an embodiment 6 according to the invention, method 2 is designed according to one of its preceding embodiments, wherein in the method step B] the irradiation of the irradiation material with the light emitted by at least a portion of the light-emitting semiconductor components of the first plurality of light-emitting semiconductor components comprises at least partially simultaneously irradiating the composition with light emitted by at least a portion of the light-emitting semiconductor components of the first type and by at least a portion of the light-emitting semiconductor components of the further type.

A contribution to the fulfilment of at least one of the objects according to the invention is made by an embodiment 1 of a use 1 of the light source of the invention according to one of its embodiments in a printing machine. A preferred printing machine is designed according to one of the embodiments of the printing machine according to the invention. Furthermore, the light source is preferably used in the printing machine for curing a composition. The composition is preferably designed according to an embodiment of method 1 according to the invention. The curing is preferably carried out according to an embodiment of method 1 according to the invention.

In an embodiment 2 according to the invention, use 1 is designed according to its embodiment 1, wherein the use comprises an at least partially simultaneous irradiation with light irradiated from at least a portion of the light-emitting semiconductor components of the first type and from at least a portion of the light-emitting semiconductor components of the further type.

A contribution to the fulfilment of at least one of the objects according to the invention is made by an embodiment 1 of a use 2 of the light source of the invention according to one of its embodiments, for a curing of a composition. The composition is preferably designed according to an embodiment of the method 1 according to the invention. In addition, the curing is preferably carried out according to an embodiment of method 1 according to the invention.

Features which are described as preferred in a category according to the invention, for example according to the device, or light source, or method 1, all according to the invention, are also preferred in an embodiment of the further categories according to the invention, for example an embodiment of the arrangement according to the invention or use 1 or 2.

### Light-Emitting Semiconductor Component

Within the scope of the invention, any component comprising a semiconductor which appears to the skilled person to be suitable as a light-emitting component of the device according to the invention, or as a light source according to the invention, is considered to be a light-emitting semiconductor component. A light-emitting component is a component which is adapted to emit electromagnetic radiation.

The definition of electromagnetic radiation includes not only visible light but also components of the electromagnetic spectrum that are invisible to the human eye. Preferred electromagnetic radiation lies in the wavelength range from 10 nm to 1 mm. Further preferred electromagnetic radiation is infrared radiation (IR radiation) or ultraviolet radiation (UV radiation), or a mixture of both, wherein UV radiation is particularly preferred. According to the DIN 5031-7 standard, the wavelength range of UV radiation extends from 10 to 380 nm. By definition, UV-A radiation is in the range from 315 to 380 nm, UV-B radiation in the range from 280 to 315 nm, UV-C radiation in the range from 100 to 280 nm, and EUV radiation in the range from 10 to 121 nm. In the context of the invention, UV radiation selected from the group consisting of UV-A radiation, UV-B radiation, and UV-C radiation, or a combination of at least two thereof, is particularly preferred. It should be taken into account that, although the aforementioned standard defines the wavelength ranges of UV radiation, in the technical field of light-emitting diodes (LED), which, as described below, are the preferred light-emitting semiconductor components within the scope of the invention, LEDs with maxima of the radiated intensity (also called peak wavelength in the technical field) at wavelengths which are not within the wavelength ranges specified in the standard are also referred to as UV LEDs. For example, LEDs with radiated intensity maxima at wavelengths of 385 nm, 395 nm and 405 nm are also referred to as UV-A LEDs. Within the scope of the invention, such LEDs are also among the preferred light-emitting semiconductor components. Furthermore, the designation of the technical field is adopted here and also such LEDs are called UV-LEDs.

Preferably, the light-emitting semiconductor components of the device according to the invention each comprise a semiconductor chip. At least the semiconductor chips of the light-emitting semiconductor components of the device mentioned in claim 1 are arranged together on the substrate of the device. A preferred light-emitting semiconductor component additionally comprises at least one optical element superimposed on the at least one semiconductor chip on a side facing away from the substrate. One or more, preferably all, of the light-emitting semiconductor components can be individually equipped with an optical element. Furthermore, an optical element can also be allocated to several light-emitting semiconductor components. In this context, an optical element is an element which is arranged and adapted to manipulate electromagnetic radiation. Possible elements are optical components as well as optical parts. A preferred optical element is one selected from the group consisting of a transmitting optical element, a converting optical element, and a reflecting optical element, or a combination of at least two thereof. A transmitting optical element is an optical element through which electromagnetic radiation passes in order to manipulate it. A preferred transmitting optical means element is a lens or transmission grating. A converting optical element is an optical element which is arranged and adapted to change a wavelength of electromagnetic radiation. In the case of an LED, this can be used to adjust the color of the light emitted by the LED. A preferred converting optical element is a conversion layer, i.e., a layer containing at least one fluorescent dye. A reflecting optical element is an optical element that reflects electromagnetic radiation in order to manipulate it, in particular its direction of propagation. A preferred reflecting optical element is a mirror or a reflection grating.

Light-emitting semiconductor components include in particular light-emitting diodes (LEDs) and laser diodes (also called semiconductor lasers), wherein light-emitting diodes are particularly preferred. A particularly preferred LED is an IR LED or a UV LED, or both, wherein UV LEDs are particularly preferred. A preferred UV LED is one selected from the group consisting of a UV-A LED, a UV-B LED, and a UV-C LED, or a combination of at least two thereof.

### Device

Any device with the features attributed to it as disclosed in this document can be considered to be a device according to the invention. In the case of an LED as a light-emitting semiconductor component, the structure described above, comprising the substrate and the semiconductor chips and, optionally, one or more optical elements, is also referred to as a package in the technical field. Preferably, at least a surface of the substrate on which the electrical circuit is arranged is adapted to be flat. It is alternatively or additionally preferred that at least the protruding surface of the substrate is electrically insulating. Furthermore, the substrate preferably comprises a ceramic material. More preferably, the substrate consists of the ceramic material. A preferred device comprises an LED module. A particularly preferred device is an LED module. An LED module principally comprises a substrate, also called a circuit board, on which one or more LEDs are arranged. In the context of the invention, several LEDs, at least a plurality of LEDs of the first type and at least one LED of the further type, are arranged on the same substrate. According to the invention, the LED module is adapted in the so-called chip-on-board technology.

### Electrical Circuit

The electrical circuit of the device according to the invention can be any related assembly of electrical conductors which appears suitable to a person skilled in the art in the context of the invention. Both electrical and electronic elements can be considered as electrical conductors.

In particular, the light-emitting semiconductor components of the device and electrically conductive connections belong to the electrical conductors. Preferred electrically conductive connections are conductive tracks and wires. Preferred conductive tracks are printed conductive tracks. Preferred wires are bonding wires. The electrical circuit of the device according to the invention comprises parallel circuit paths. These are paths in the electrical circuit, which are connected in parallel to each other at least in sections. These paths do not necessarily have to be geometrically parallel. Rather, the parallel circuit paths of each section of the current circuit are connected in parallel with each other, but preferably not all parallel circuit paths of one section are connected in parallel with all parallel circuit paths of another section of the electrical circuit. Rather, preferably each further section comprises a parallel circuit path which is connected in series to one of the parallel circuit paths of the first section. The parallel circuit paths of one and the same section may overlap each other. This means that a conductor can belong to several parallel circuit paths. Several parallel circuit paths of a section can therefore merge into one path, for example in a longitudinal bar of a double-T-shaped conductive track. In this case, each branch is called a parallel circuit path. The electrical circuit of the device according to the invention preferably comprises the first section and at least one, preferably at least two, more preferably at least three, even more preferably at least four further sections. The first and the at least one further section are preferably essentially identically constructed. This means that the aforementioned sections are identical with regard to the selection of their electrical components and their interconnection, wherein the sections may differ in certain sections by the presence or absence of electrical contacts for connecting further elements, such as a voltage source, for example. The electrical circuit of the device is arranged on the substrate, i.e., the electrical circuit is superimposed on the substrate. Preferably, the electrical circuit is adjacent to a surface of the substrate. It is alternatively or additionally preferred that the electrical circuit is bonded to the substrate.

### Operating Voltage

According to VDE 0100-200, the operating voltage is the voltage present locally between the conductors of electrical devices. In contrast to the nominal voltage, which refers to the manufacturer's design, the operating voltage describes the voltage with which the device is actually operated. If a light-emitting semiconductor component allows electric current to pass in only one direction, this direction is called the forward direction. In this case, the light-emitting semiconductor component is operated in the forward direction by applying its operating voltage, i.e., when this forward voltage is applied, the light-emitting semiconductor component emits light. This applies preferably to LEDs. A forward voltage is preferred as the operating voltage. Furthermore, a preferred operating voltage sum is a forward voltage sum.

### Light Source

Within the context of the invention, any device adapted for emitting electromagnetic radiation using the light-emitting semiconductor components of the device according to the invention, which appears to the skilled person to be suitable for use according to the invention, preferably for use in a printing machine, can be considered as a light source. Preferably the light source is an electric light source. It is additionally or alternatively preferred that the light source is a lighting component or a luminaire. A luminaire is a device in which a lighting component is, or can be, installed, and which serves for illumination. The lighting component of the luminaire preferably comprises the device in accordance with the invention. The term illumination is to be understood in a broad sense, so that any type of targeted irradiation with electromagnetic radiation, especially for industrial applications, is considered. A preferred lighting component is an LED lighting component. A preferred luminaire is an LED luminaire. The light source also preferably comprises a ballast, which is arranged and adapted to operate an LED module. A preferred ballast is an LED driver. The light source preferably comprises a housing which partially surrounds the device according to the invention. Furthermore, the light source preferably comprises an emission window which is arranged on a side of the substrate facing the electrical circuit. The emission window preferably consists of a quartz glass. Furthermore, the light source preferably comprises a mechanism for cooling the light source. A preferred mechanism of cooling is cooling channels for conducting a cooling fluid or a cooling structure, or both. A preferred cooling structure comprises one selected from the group consisting of flaps, cooling ribs, pores, and channels, or a combination of at least two thereof. Cooling ribs are also called cooling fins. A cooling fluid is any fluid which the skilled person may consider suitable in the context of the invention, in particular for cooling the light source of the invention. In this context, a fluid is a flowable medium. This includes in particular gases and liquids. A cooling liquid is preferred as a cooling fluid. A preferred cooling liquid comprises water or glycol, or a mixture of both. A preferred cooling liquid consists of water or a water-glycol mixture.

### Superimposing

If it is defined in this document that an element, for example a layer or a component, superimposes another element, these elements can follow each other directly, i.e., without any intermediate element, or indirectly, i.e., with at least one intermediate element. Directly following elements are preferably adjacent to each other, i.e., they are in contact with each other. Furthermore, elements superimposing each other are preferably bonded to each other. Elements superimposing each another can be directly or indirectly bonded with one another. Two elements are bonded to each other if their adhesion to each other exceeds Van der Waals attraction forces. Bonded elements are preferably selected from the group consisting of soldered, welded, sintered, screwed and adhesively bonded together, or a combination of at least two thereof. A formulation in which a sequence of layers or coatings comprises enumerated layers or coatings means that at least the enumerated layers or coatings are present in the enumerated order. This formulation does not necessarily imply that these layers or coatings follow each other directly. A formulation in which two layers are adjacent to each other means that these two layers follow each other directly and thus without an intermediate layer. If, in a sequence of layers, one layer superimposes another layer, then the layer does not necessarily superimpose the other layer over the entire area of one or the other layer, but preferably over a surface region of the two layers. The layers forming the sequence of layers of the sheet-like composite are preferably bonded with each other in a laminar manner.

### Curing

The curing of a composition is herein a solidification of the composition, wherein a layer is obtained from the composition, which is preferably also bonded to the underlying item during curing. The layer can be a layer that is continuous, which is preferred as a composition in the case of a lacquer, or a non-continuous layer, for example in the form of letters formed from a printing ink. A preferred curing is physical curing or chemical curing, or both. A preferred physical curing is drying. Drying preferably comprises reducing a proportion of a vehicle in the composition, preferably to 0 wt-%, preferably by evaporation of the vehicle. A preferred vehicle is an organic vehicle or an inorganic vehicle. Water is the preferred inorganic vehicle. Another preferred vehicle is a solvent. Chemical curing involves a chemical reaction. A preferred chemical reaction is a polymerization reaction or a crosslinking reaction, or both. If the composition is a powdered composition, curing involves bonding particles of the powdered composition to form a cohesive solid, which is preferably also bonded to the underlying item. In the case of a liquid composition, the composition changes from the liquid state to the solid state during curing.

### Print Carrier

Any item that appears suitable to the skilled person in the context of the invention can be considered as a print carrier, also called a print substrate. A preferred print carrier has a planar shape. This means that a length and a width of the print carrier are larger than a thickness of the print carrier by a factor of at least 10, preferably at least 100, even more preferably at least 1,000. A preferred planar print carrier is in the form of a web. This means that a length of the print carrier is greater than a width of the print carrier by a factor of at least 2, more preferably at least 5, even more preferably at least 10, most preferably at least 100. A preferred print carrier comprises, preferably consists of, paper, a film or a laminate. A preferred laminate comprises one or more polymer layers, one or more paper layers, one or more metal layers, or a combination of the aforementioned layers in a layer sequence.

### Printing Ink

Printing inks are mixtures containing colorants that have a suitable viscosity for application as a thin layer. The thin layer in a cured state preferably has a thickness (dry thickness) in the range of 0.5 to 50 μm, preferably from 1 to 30 μm, more preferably from 1 to 20 μm. A preferred printing ink comprises one selected from the group consisting of one or more colorants, a binder, a vehicle, and an additive, or a combination of at least two, preferably all, of the aforementioned. A preferred binder is a resin or a polymer, or a mixture of both. A preferred vehicle is a solvent. A preferred additive is used to adjust a desired property of the printing ink, preferably a desired processing property, for example a viscosity of the printing ink. A preferred additive is one selected from the group consisting of a dispersing additive, a defoamer, a wax, a lubricant, and a substrate wetting agent, or a combination of at least two thereof. Furthermore, a preferred printing ink is one selected from the group consisting of a toner, an ink for an inkjet printer, an offset printing ink, an illustration printing ink, a liquid ink, and a radiation curing printing ink, or a combination of at least two thereof. A preferred offset printing ink is a web-fed offset printing ink or a sheet-fed offset printing ink, or both. A web-fed offset printing ink is a coldset web offset printing ink or a heatset web offset printing ink, or both. A preferred liquid ink is a water-based liquid ink or a solvent-based liquid ink, or both. A particularly preferred printing ink comprises from 8 to 15 wt-% of at least one colorant, preferably at least one pigment, and in total 25 to 40 wt-% of at least one resin or at least one polymer, or a mixture of the two, from 30 to 45 wt-% of at least one high-boiling mineral oil (boiling range 250 to 210° C.), and in total 2 to 8 wt-% of at least one additive, each based on the weight of the printing ink.

### Lacquer

A lacquer is a liquid or powdered coating material which has a suitable viscosity for application as a thin layer and from which a solid, preferably continuous, film can be obtained by curing. Lacquers often comprise at least one selected from the group consisting of at least one binder, at least one filler, at least one vehicle, at least one colorant, at least one resin and/or at least one acrylate, and at least one additive, or a combination of at least two thereof, wherein a combination of all the above-mentioned components (with resin and/or acrylate) is preferred. A preferred additive is a biocide. A preferred biocide is a pot preservative. Lacquers are often used to protect the object to which they are applied, for decoration, to functionally modify a surface of the object, for example to change its electrical properties or resistance to abrasion, or a combination of the abovementioned functions. A lacquer preferred in the context of the invention is one selected from the group consisting of a water-based lacquer, a solvent-based lacquer, a UV-based, i.e., UV-curable, lacquer, and a dispersion lacquer, or a combination of at least two thereof. A particularly preferred lacquer is adapted to protect a printed surface.

### Colorants

Both solid and liquid colorants known to the skilled person and suitable for the present invention can be considered as colorants. According to DIN 55943:2001-10, “colorant” is the collective name for all coloring materials, especially for dyes and pigments. A preferred colorant is a pigment. A preferred pigment is an organic pigment. Pigments of note in the context of the invention are in particular those in DIN 55943:2001-10, and those in Industrial Organic Pigments, Third Edition (Willy Herbst, Klaus Hunger Copyright © 2004 WILEY-VCH Verlag GmbH & Co. KGaA, Weinheim ISBN: 3-527-30576-9). A pigment is a colorant that is preferably insoluble in the application medium. A dye is a colorant which is preferably soluble in the application medium.

### Method Steps

In a method described herein, the method steps are performed in the order as indicated by the order of their reference numbers. The steps in a sequence of steps can follow each other directly or indirectly. In addition, successive method steps can be carried out one after the other, with a time overlap or also be simultaneous.

### Test Methods

Unless otherwise indicated, the measurements made in the context of the invention were made at an ambient temperature of 23° C., an ambient air pressure of 100 kPa (0.986 atm), and a relative humidity of 50%.

### Operating Voltage and Operating Current

The operating voltage can be taken from the manufacturer's specifications. The operating current is obtained from the current-voltage characteristic curve, also provided by the manufacturer. For LEDs in particular, the forward voltage and the current-voltage characteristic curve are automatically measured by the manufacturer during so-called binning, i.e., sorting according to quality classes, and are usually specified in a data sheet.

### Spectrum and Full-Width-at-Half-Maximum

The spectrum is measured with a USB2000+ spectrometer from Ocean Optics. The full-width-at-half-maximum of intensity maxima are determined using suitable analysis software, preferably the software supplied with the instrument.

It is to be understood that both the foregoing general description and the following detailed description are exemplary, but are not restrictive, of the disclosure.

### BRIEF DESCRIPTION OF THE DRAWING

The invention is described in more detail below by examples and drawings, wherein the examples and drawings do not constitute a limitation of the invention. Furthermore, the drawings are not to scale, unless otherwise indicated.

Unless otherwise indicated in the description or the respective figure, they are schematic and not to scale:

FIG. 1 is a schematic representation of a device according to the invention;

FIG. 2 is a schematic representation of a further device according to the invention;

FIG. 3a) is a schematic representation of a further device according to the invention;

FIG. 3b) is a schematic representation of a further device according to the invention of circuit paths of the electrical circuit of the device according to the invention of FIG. 3a);

FIG. 4 is a schematic representation of a light source according to the invention;

FIG. 5 is a schematic representation of a printing machine according to the invention;

FIG. 6 is a flowchart of a method according to the invention for producing a printed product;

FIG. 7 is a schematic representation of a printed product according to the invention;

FIG. 8 is a schematic representation of an arrangement according to the invention; and

FIG. 9 a flow chart of a method according to the invention for irradiating an irradiation material.

### DETAILED DESCRIPTION OF THE DISCLOSURE

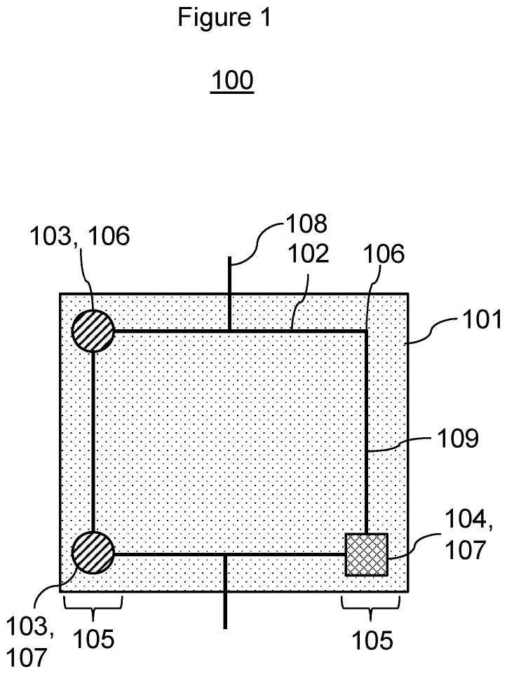

FIG. 1 shows a schematic representation of a device 100, which comprises a substrate 101 of aluminum oxide. On the substrate 101 is an electrical circuit 102 of conductive tracks 109, electrical contacts 108 for connecting a voltage source, and a first plurality of light-emitting semiconductor components. The first plurality of light-emitting semiconductor components consists in the illustrated embodiment of two light-emitting semiconductor components of a first type 103 and one light-emitting semiconductor component of a further type 104. The light-emitting semiconductor components of the first type 103 are arranged and adapted to emit light with a spectrum comprising a local intensity maximum in a first wavelength range when an operating voltage of the light-emitting semiconductor components of the first type 103 is applied. In contrast thereto, the light-emitting semiconductor component of the further type 104 is arranged and adapted to emit light with a spectrum comprising a local intensity maximum in a further wavelength range, different from the first wavelength range, when an operating voltage of the light-emitting semiconductor component of the further type 104 is applied. The conductive tracks 109 and the light-emitting semiconductor components of the first plurality are arranged in such a manner that the electrical circuit 102 comprises two parallel circuit paths 105 connected in parallel to each other. Each of these parallel circuit paths 105 has a first end 106 and a further end 107 opposite its first end 106. The first ends 106 of the two parallel circuit paths 105 are electro-conductively connected to each other by one of the conductive tracks 109. In addition, the further ends 107 of the two parallel circuit paths 105 are electro-conductively connected to each other by another of the conductive tracks 109. The two light-emitting semiconductor components of the first type 103 are arranged together in one of the two parallel circuit paths 105. The light-emitting semiconductor component of the further type 104 is arranged in the other parallel circuit path 105. Each of the two parallel circuit paths 105 is characterized by a sum of operating voltages, which is a sum of the operating voltages of the light-emitting semiconductor components in the respective parallel circuit path 105. The two operating voltage sums differ in this embodiment by no more than 0.3 V.

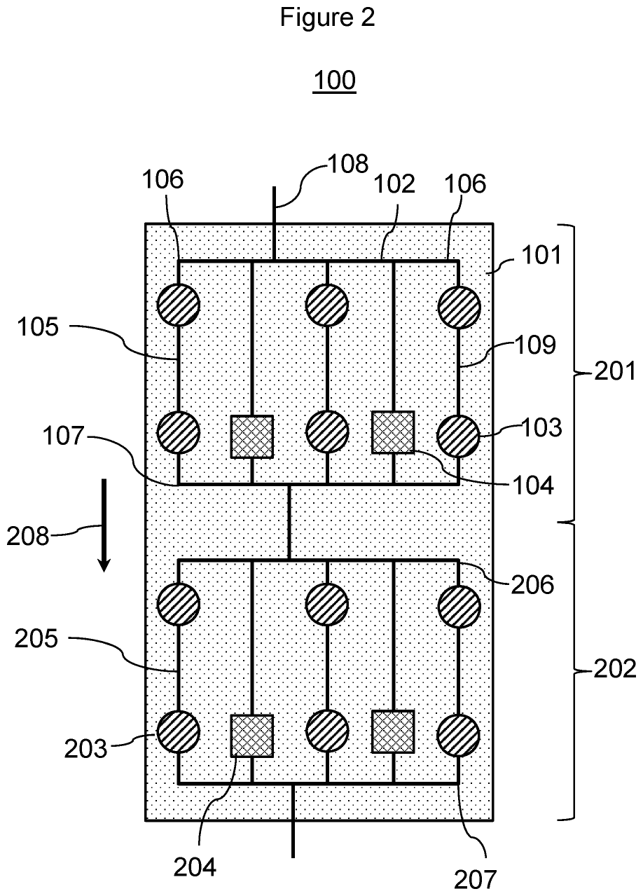

FIG. 2 shows a schematic representation of a further device 100 according to the invention, which in turn comprises a substrate 101 made of a ceramic material such as aluminum nitride. The substrate 101 is a planar circuit board with flat surfaces. An electrical circuit 102 is directly applied to one of these flat surfaces. This electrical circuit 102 comprises electrical contacts 108 for connecting a voltage source, printed conductive tracks 109, and light-emitting semiconductor components, which are UV-LEDs. The electrical circuit 102 consists of a first section 201 and a further section 202, which are identical except for the mirror-inverted assembly of the electrical contacts 108 and a conductive track 109 electro-conductively connecting the two sections 201, 202. Of the light-emitting semiconductor components of the device 100, the first section 201 comprises a first plurality of the light-emitting semiconductor components and the further section 202 comprises a further plurality of the light-emitting semiconductor components. The first plurality of light-emitting semiconductor components consists of six light-emitting semiconductor components of a first type 103 and two light-emitting semiconductor components of a further type 104. Consequently, the further plurality of light-emitting semiconductor components also consists of six light-emitting semiconductor components of the first type 203 and two light-emitting semiconductor components of the further type 204. The light-emitting semiconductor components of the first type 103, 203 are UV-A LEDs with an intensity maximum of their emission spectrum at 365 nm. The UV-A LEDs are of a binning class, which defines an operating voltage in a range of 3.3 to 3.4 V. The light-emitting semiconductor components of the further types 104, 204 are UV-C LEDs with an intensity maximum of their emission spectrum at 250 nm. Further, a binning class of UV-C LEDs defines an operating voltage in a range of 6.7 to 6.8 V. Still further, each UV-LED of the device 100 is characterized by a forward direction 208. This is represented in FIG. 2 by an arrow. The first section 201 and the further section 202 of the electrical circuit 102 each comprise five parallel circuit paths 105 and 205, respectively, connected in parallel. Each parallel circuit path 105 of the first section 201 has a first end 106 and a further end 107 opposite its first end 106 in the forward direction 208. Each parallel circuit path 205 of the further section 202 also has a first end 206 and a further end 207 opposite its first end 206 in the forward direction 208. The first ends 106 of the parallel circuit paths 105 of the first section 201 are electro-conductively connected to each other by one of the conductive tracks 109. In addition, the further ends 107 of the five parallel circuit paths 105 of the first section 201 are electro-conductively connected to each other by another of the conductive tracks 109. The same applies analogously to the first ends 206 and the further ends 207 of the parallel circuit paths 205 of the further section 202. Each of the parallel circuit paths 105, 205 is characterized by a sum of operating voltages, which is a sum of the operating voltages of the UV LED in the respective parallel circuit path 105, 205. The operating voltage sums of the parallel circuit paths 105 of the first section 201 do not differ from each other by more than 0.2 V. The same applies to the operating voltage sums of the parallel circuit paths 205 of the further section 202. This allows, in particular, the joint operation of the UV-A LED and the UV-C LED in the electrical circuit 102 on the substrate 101 which is formed as one piece. This enables an emission spectrum specifically adapted to a certain UV-curable ink, and at the same time stripes and steps in an intensity distribution on an irradiation surface can be avoided. Furthermore, none of the UV LEDs of a parallel circuit path 105 of the first section 201 is connected in series with a UV LED of a different parallel circuit path 105 of the first section 201. Similarly, none of the UV LEDs of a parallel circuit path 205 of the further section 202 is connected in series with a UV LED of a different parallel circuit path 205 of the further section 202. This reduces the susceptibility of the device 100 to failure, especially in the event of a failure of a single UV LED. If a single UV-LED fails, the number of UV-LEDs that are forced to fail is limited. As a result, the device 100 often does not have to be maintained or replaced if a single UV LED fails, but can still be operated. This increases the service life of the device 100.

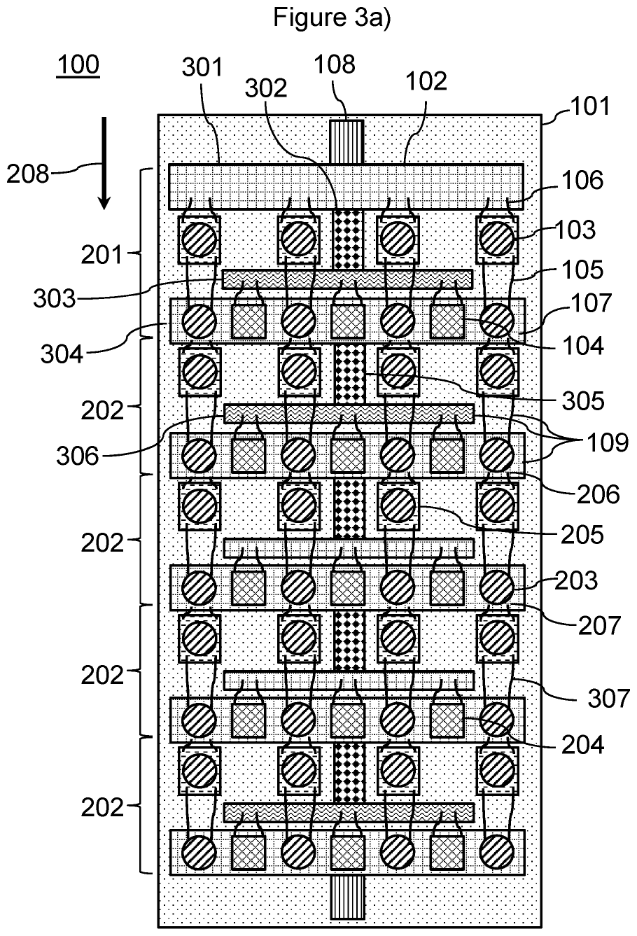

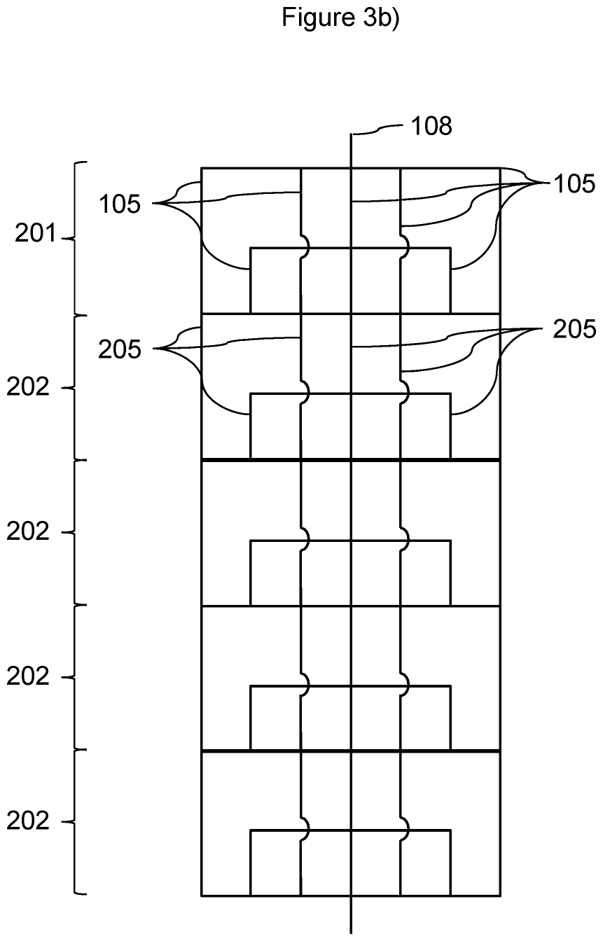

FIG. 3a) shows a schematic representation of a further device 100 according to the invention. A substrate 101 of the device 100 consists of aluminum oxide. The substrate 101 is a planar circuit board with flat surfaces formed as one piece. An electrical circuit 102 is directly applied to one of these flat surfaces. This electrical circuit 102 comprises electrical contacts 108 for connecting a voltage source, conductive tracks 109 and light-emitting semiconductor components, which are UV LEDs. The electric circuit 102 consists of a first section 201 and four further sections 202. Of the light-emitting semiconductor components of the device 100, the first section 201 comprises a first plurality of light-emitting semiconductor components, and each of the further sections 202 comprises a further plurality of light-emitting semiconductor components. The first plurality of light-emitting semiconductor components consists of eight light-emitting semiconductor components of a first type 103 and three light-emitting semiconductor components of a further type 104. Furthermore, each further plurality of light-emitting semiconductor components also consists of eight light-emitting semiconductor components of the first type 203 and three light-emitting semiconductor components of the further type 204. The light-emitting semiconductor components of the first type 103, 203 are UV-A LEDs each with an operating voltage of about 3.3 V. The light-emitting semiconductor components of the further type 104, 204 are UV-C LEDs each with an operating voltage of about 6.6 V each. Furthermore, each UV LED of the device 100 is characterized by a forward direction 208. This is represented in FIG. 3a) by an arrow. The conductive tracks 109 of the electrical circuit 102 comprise five double-T-shaped conductive tracks. Each of these double-T-shaped conductive tracks consists of a first transverse bar 301 or 304, a further transverse bar 303 or 306, and a longitudinal bar 302 or 305 electrically connecting the first transverse bar to the further transverse bar. The first transverse bar, the longitudinal bar and the further transverse bar of each double-T-shaped conductive track are adjacent to each other in this order in the forward direction 208. Further conductive tracks 109 of the device 100 are bonding wires 307. The first section 201 of the electrical circuit 102 comprises seven parallel circuit paths 105 connected in parallel to one another (see FIG. 3b)). Each further section 202 of the electrical circuit 102 also comprises seven parallel circuit paths 205 connected in parallel to one another (see FIG. 3b)). Each parallel circuit path 105 of the first section 201 has a first end 106 and a further end 107 opposite its first end 106 in the forward direction 208. Each parallel circuit path 205 of each further section 202 also has a first end 206 and a further end 207 opposite its first end 206 in the forward direction 208. The first ends 106 of each parallel circuit path 105 of the first section 201 are electro-conductively connected to each other by the first transverse bar 301 of a first double-T-shaped conductive track. Furthermore, the further ends 107 of the seven parallel circuit paths 105 of the first section 201 are electro-conductively connected to each other by the first transverse bar 304 of a further double-T-shaped conductive track. Similarly, the first ends 206 and the further ends 207 of the parallel circuit paths 205 of each further section 202 are connected to each other by a first transverse bar 304 of a further double-T-shaped conductive track. In each of the sections 201, 202, two of the total of eight UV-A-LEDs are arranged together in one of the seven parallel circuit paths 105, 205 while one of the total of three UV-C-LEDs is arranged in one of the other seven parallel circuit paths 105, 205. The eight UV-A LEDs of a section 201, 202 each comprise two UV-A LEDs of the same emission spectrum, wherein the emission spectra of the UV-A LEDs otherwise differ from each other. Two of the eight UV-A LEDs of a section 201, 202 have an emission spectrum with a local intensity maximum at 365 nm, two other UV-A LEDs have an emission spectrum with a local intensity maximum at 385 nm, two other UV-A LEDs have an emission spectrum with a local intensity maximum at 395 nm, and two UV-A LEDs have an emission spectrum with a local intensity maximum at 405 nm. In each case two UV-A LEDs with the same emission spectrum are arranged together in a parallel circuit path 105, 205. The three UV-C LEDs of each section 201, 202 are distributed such that one UV-C LED is in each of the three remaining parallel circuit paths 105, 205 of the section 201, 202. These three remaining parallel circuit paths 105, 205 of each section 201, 202 overlap each other in a longitudinal bar 302, 305 of a double-T-shaped conductive track. Each of the parallel circuit paths 105, 205 is characterized by a sum of operating voltages, which is a sum of the operating voltages of the UV LED in the respective parallel circuit path 105, 205. It follows that the operating voltage sums of the parallel circuit paths 105 of the first section 201 do not differ from each other by more than 0.1 V. The same applies to the operating voltage sums of the parallel circuit paths 205 of each further section 202. The assembly of UV-A LED and UV-C LED described above allows a total emission spectrum of a light source 400 to be modified very flexibly and easily for different UV-curable printing inks or lacquers to be irradiated with a device 100. Furthermore, none of the UV LEDs of a parallel circuit path 105 of the first section 201 is connected in series with a UV LED of a different parallel circuit path 105 of the first section 201. Similarly, none of the UV LEDs of a parallel circuit path 205 of a further section 202 is connected in series with a UV LED of a different parallel circuit path 205 of the same further section 202. This reduces the susceptibility to failure of a light source 400 with the device 100. The UV-C LEDs of the first section 201 are electro-conductively connected to the longitudinal bar 302 and the further transverse bar 303 of the first double-T-shaped conductive track by bonding wires 307. Furthermore, the first transverse bar 301 of the first double-T-shaped conductive track is electro-conductively connected along each of the parallel circuit paths 105 of the first section 201 by bonding wires 307 to the first transverse bar 304 of the further double-T-shaped conductive track in a following manner and in the forward direction 208. In addition, the further transverse bar 303 of the first double-T-shaped conductive track is electro-conductively connected along each parallel circuit path 105 of the four parallel circuit paths 105 of the first section 201 equipped with UV-A LEDs by bonding wires 307 to the first transverse bar 304 of the further double-T-shaped conductive track in a following manner and in the forward direction 208. The double-T-shaped conductive tracks are screen-printed conductive tracks. The above described combination of bonding wires 307 and printed conductive tracks in the described assembly of the electrical circuit 102 makes it possible to manufacture the device 100 simply and efficiently, and also allows a light source 400 with the device 100 to be made in a particularly compact manner.

FIG. 3b) shows a schematic representation of circuit paths of the electrical circuit 102 of the device 100 according to the invention. In comparison with FIG. 3a), it can be seen that the electrical circuit 102 comprises seven parallel circuit paths 105 in the first section 201 and seven parallel circuit paths 205 in each further section 202.

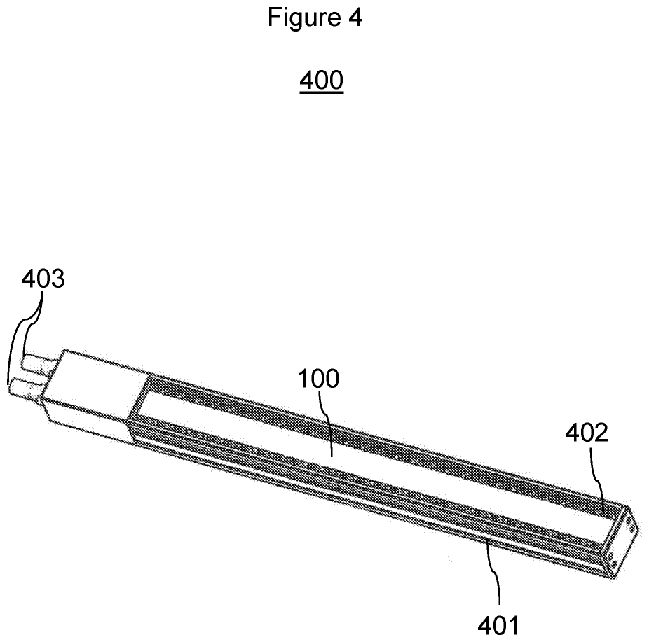

FIG. 4 shows a schematic representation of a light source 400 according to the invention. This light source 400 is a UV luminaire of the UV4000 Semray class from Heraeus Noblelight GmbH, which was retrofitted with a device 100 according to the invention, and according to the structure shown in FIG. 3a), as an LED package. The device 100 is partially surrounded by a housing 401 of the device 100. Furthermore, the light source 400 comprises an emission window 402 made of quartz glass, which is arranged on one side of the substrate 101 facing the electrical circuit 102 of the device 100. The light source 400 further comprises connections 403 for an inflow and an outflow of a cooling fluid for cooling the device 100.

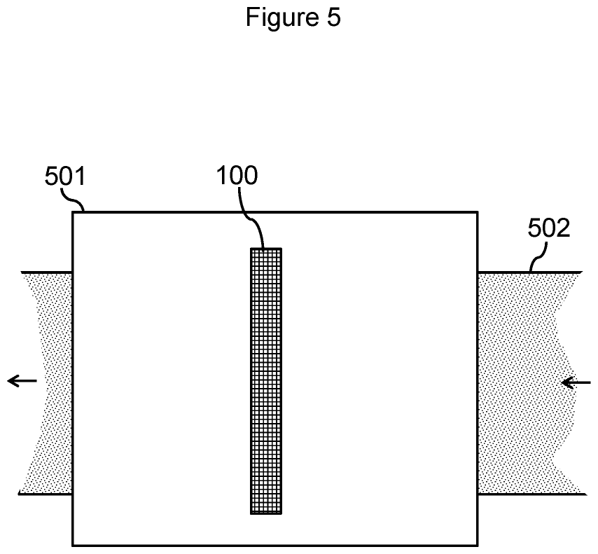

FIG. 5 shows a schematic representation of a printing machine 501 according to the invention. The printing machine 501 comprises the light source 400 of FIG. 4. The light source 400 is arranged in the printing machine 501 to irradiate a composition printed on a print carrier 502. The printing machine 501 is a sheet-fed offset printing machine.

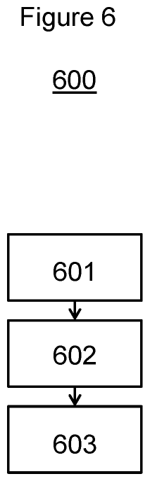

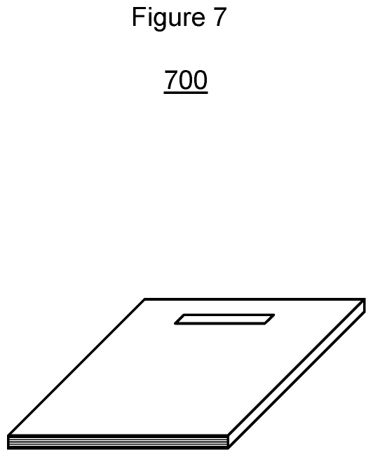

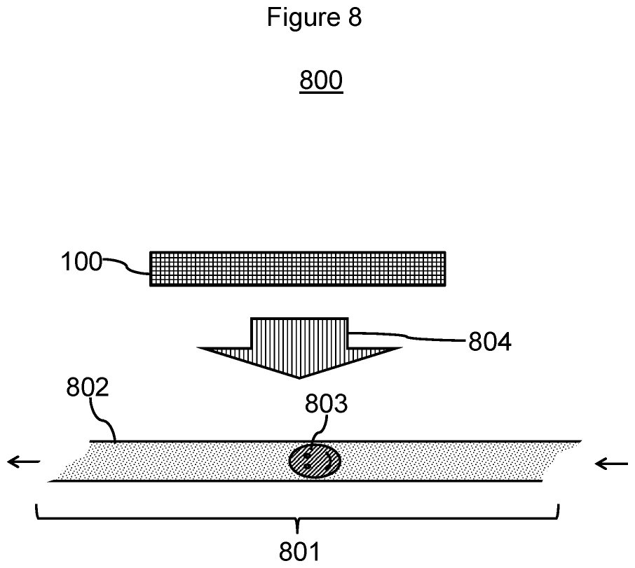

FIG. 6 shows a flow chart of a method 600 according to the invention for the production of a printed product 700 (see FIG. 7). In the first method step 601, the printing machine 501 of FIG. 5 and a print carrier 802 are provided as an item (see FIG. 8). In a subsequent method step 602, a liquid composition 803, which is a sheet-fed offset printing ink, is printed on the print carrier 802 with the printing machine 501. In a third method step 603, the printed sheet-fed offset printing ink is simultaneously irradiated with UV light 804, emitted by UV-A LEDs with different emission spectra and by UV-C LEDs of the light source 400, and is thereby cured by polymerization. The intensity distribution of the UV light 804 produced in the method step 603 on the print carrier 802 or the sheet-fed offset printing ink is very homogeneous and, in particular, does not show any stripes or steps. In addition, a total spectrum of the UV light 804 is adjusted to the sheet-fed offset printing ink. This means that the sheet-fed offset printing ink can be cured very efficiently and evenly across the print carrier 802.

FIG. 7 shows a schematic representation of a printed product 700 according to the invention. As illustrated in this embodiment, the printed product 700 is a brochure obtained by the method 600 of FIG. 8.

FIG. 8 shows a schematic representation of an arrangement 800 according to the invention. The arrangement 800 comprises the printing machine 501 of FIG. 5 and an irradiation material 801, which consists of an item including a print carrier 802 and a printing ink 803 printed on the print carrier 802. The light source 400 of the printing machine 501 and the irradiation material 801 are arranged such that the printed printing ink 803 can be irradiated with the UV light 804 emitted by the UV LED of the light source 400.

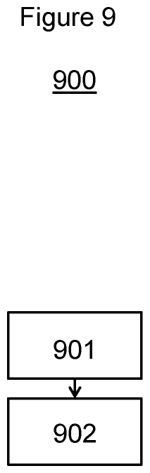

FIG. 9 shows a flowchart of a method 900 according to the invention for irradiating an irradiation material 801. In a first method step 901, the arrangement 800 of FIG. 8 is provided. In a second method step 902, the irradiation material 801 is irradiated simultaneously with the UV light 804, emitted by UV-A LEDs of different emission spectra and by UV-C LEDs of the light source 400.

Although illustrated and described above with reference to certain specific embodiments and examples, the present disclosure is nevertheless not intended to be limited to the details shown. Rather, various modifications may be made in the details within the scope and range of equivalents of the claims and without departing from the spirit of the disclosure.

What is claimed:

1. A device comprising:
a substrate; and
an electrical circuit arranged on the substrate and having a first section with (i) a first plurality of light-emitting semiconductor components including a plurality of light-emitting semiconductor components of a first type and at least one light-emitting semiconductor component of a further type, and (ii) a first plurality of parallel circuit paths connected in parallel with each of the parallel circuit paths of the first plurality of parallel circuit paths having a first end and an oppositely positioned further end,
wherein the first ends of the parallel circuit paths of the first plurality of parallel circuit paths are electro-conductively connected to each other and the further ends of the parallel circuit paths of the first plurality of parallel circuit paths are electro-conductively connected to each other;
wherein each light-emitting semiconductor component of the first type is arranged and adapted to emit light with a spectrum comprising a local intensity maximum in a first wavelength range upon application of an operating voltage of the light-emitting semiconductor component of the first type;
wherein each light-emitting semiconductor component of the further type is arranged and adapted to emit light with a spectrum comprising a local intensity maximum in a further wavelength range, different from the first wavelength range, upon application of an operating voltage of the light-emitting semiconductor component of the further type;
wherein at least one of the parallel circuit paths of the first plurality of parallel circuit paths comprises a light-emitting semiconductor component of the further type;
wherein each parallel circuit path of the first plurality of parallel circuit paths has an operating voltage sum, which is a sum of the operating voltages of the light-emitting semiconductor components in the respective parallel circuit path; and
wherein no operating voltage sum of the parallel circuit paths of the first plurality of parallel circuit paths differs by more than 0.6 V from an operating voltage sum of the parallel circuit paths of the first plurality of parallel circuit paths.

2. The device according to claim 1, wherein the first wavelength range is from 315 to 450 nm; or the further wavelength range is from 280 to less than 315 nm, or from 10 to less than 280 nm, or both; or the first wavelength range is from 315 to 450 nm and the further wavelength range is from 280 to less than 315 nm, or from 10 to less than 280 nm, or both.

3. The device according to claim 1 wherein the light-emitting semiconductor components of the first type have first operating voltages and the light-emitting semiconductor components of the further type have further operating voltages different from the first operating voltages.

4. The device according to claim 1 wherein no light-emitting semiconductor component of a parallel circuit path of the first plurality of parallel circuit paths is connected in series with a light-emitting semiconductor component of a different parallel circuit path of the first plurality of parallel circuit paths.

5. The device according to claim 1 wherein the electrical circuit has a first double-T-shaped conductive track including a first transverse bar, a further transverse bar, and a longitudinal bar electrically connecting the first transverse bar with the further transverse bar.

6. The device according to claim 1 wherein the light-emitting semiconductor components of the first type are UV-A light-emitting diodes.

7. The device according to claim 1 wherein the light-emitting semiconductor components of the further type are UV-B light-emitting diodes or UV-C light-emitting diodes or a mixture of UV-B light-emitting diodes and UV-C light-emitting diodes.

8. The device according to claim 1 wherein the light-emitting semiconductor components of the first plurality of light-emitting semiconductor components are UV light-emitting diodes.

9. A light source comprising the device according to claim 1.

10. A printing machine comprising a light source including the device according to claim 1.

11. A method comprising the steps of:
providing an item and a light source including the device according to claim 1;
superimposing the item with a composition; and
irradiating the composition with light emitted from at least a portion of the light-emitting semiconductor components of the first plurality of light-emitting semiconductor components.

12. The method according to claim 11 wherein the step of irradiating the composition includes curing the composition.

13. A printed product obtained by the method according to claim 11.

14. A printed product obtained by the method according to claim 12.

15. An arrangement comprising:
a light source including the device according to claim 1; and
an irradiation material,
wherein the light source and the irradiation material are arranged and adapted for irradiating the irradiation material with light emitted from at least a portion of the light-emitting semiconductor components of the first plurality of light-emitting semiconductor components.

16. A method comprising the steps of:
providing an arrangement having a light source including the device according to claim 1 and an irradiation material, wherein the light source and the irradiation material are arranged and adapted for irradiating the irradiation material with light emitted from at least a portion of the light-emitting semiconductor components of the first plurality of light-emitting semi-conductor components; and
irradiating the irradiation material with light emitted from at least a portion of the light-emitting semiconductor components of the first plurality of light-emitting semiconductor components.

17. A use of a light source including the device according to claim 1 in a printing machine.

18. A use of a light source including the device according to claim 1 to cure a composition.
